(19) United States
(12) Patent Application Publication
(10) Pub. No.: US 2023/0419337 A1
(43) Pub. Date: Dec. 28, 2023

(54) DIGITALPASS SYSTEM AND METHOD

(71) Applicant: LOUIS LOMBARDI, QUAKERTOWN, PA (US)

(72) Inventor: LOUIS LOMBARDI, QUAKERTOWN, PA (US)

(73) Assignee: THE WALLET GROUP, GILBERTVILLE, PA (US)

(21) Appl. No.: 17/866,524

(22) Filed: Jul. 17, 2022

Related U.S. Application Data
(60) Provisional application No. 63/356,108, filed on Jun. 28, 2022.

(51) Int. Cl. G06Q 30/02; H04L 9/32; G06F 21/62

(52) U.S. Cl. CPC G06Q 30/02; H04L 9/3213; G06F 21/6245

(57) ABSTRACT

Disclosed is a digital pass system that includes a network interface assembly including one or more computerized network devices. A promotional environment has at least one or more of spatial, temporal, material, and risk elements, the risk elements designed to calculate outcome probabilities. Included is at least one user interface wherein users may create through a digital pass portal at least one digital pass on at least one computerized device designed to accept receipt of at least one or more of information, coupons, and transactions via the network interface assembly. The network interface assembly is designed to send information to the at least one digital pass as prompted by a digital pass software based on at least one or more of the location of the at least one user, the time, the material associated with the information, and the probability the at least one user will respond positively.

### FIELD OF THE INVENTION

The inventive concept relates generally to a digital pass system and method designed to allow people to receive electronic messages from product and service entities without requiring those people to provide private information.

### BACKGROUND

Obstacles exist that inhibit customers from adopting digital promotional systems. Chief among these obstacles are requirements to provide identity information which both takes time and reduces privacy. Mobile marketing technologies generally require users to provide personal information such as email and phone numbers, which users may prefer to keep confidential before application downloads are permitted. Required information creates friction and effort. Installations are required. Downloads are required. Information is required. Traditional applications require full installations to be added and typically require registrations that demand some type of identifying information. Cancelling a registration can also take burdensome effort for users and provide further friction, even for trials. Therefore, there is a need in the market for an improved way to promote digital information.

### SUMMARY OF THE INVENTION

Disclosed is a digital pass system and method designed to allow people via at least one computerized device to opt in to receive electronic messages, such as product promotions or information, without requiring people to submit or allowing access to their personal information.

One embodiment of the digital pass system includes a network interface assembly including one or more network devices. At least one control circuit assembly is designed to receive and transmit information via the network interface assembly. A promotional environment is designed to contain at least one user, the user detected from at least one mobile device, the promotional environment having at least one or more of a spatial element, a temporal element, a material element, and a risk element, the risk element designed to calculate outcome probabilities. At least one or more of an NFC tag, global positioning system GPS, Bluetooth beacon assembly, and a geofencing system is designed for determining a presence of the at least one user.

A user may be a recipient of a digital pass. A user may also be an issuer of a digital pass or a person working on behalf of an issuing entity.

The inventive concept includes at least one user interface wherein at least one user may create through a digital pass portal at least one digital pass on at least one computerized device designed to accept receipt of at least one or more of information, coupons, and transactions via the network interface assembly, the user interface disposed on at least one mobile computerized device designed to receive a user component of the digital pass system by at least one or more of scanning and tapping an optical code, a computer link, text, email, and an NFC tag. The at least one mobile computerized device is designed to register at least one push notification service to provide a unique, secure, and randomized token into the digital pass wherein the digital pass software can determine if, when, and to whom to send information via the network interface assembly.

The network interface assembly is designed to send information to the at least one digital pass as prompted by the digital pass software based on at least one or more of the a location of the at least one user, the a time, the a material associated with the information, and the a probability the at least one user will respond to information positively, the probability further determined by at least one or more of past behavior statistics, and predictive algorithms, the predictive algorithms further designed to use data the user has permitted the digital pass software to receive. The at least one user initiates the receipt of at least one or more of information, coupons, and transactions by at least one or more of moving within the promotional environment and sending a request for a digital pass.

One embodiment of the digital pass system provides at least one user interface screen to allow the at least one user to select from at least one digital pass type from a plurality of possible types, choose from at least one action for the digital pass, configure the at least one digital pass, design the at least one digital pass, and activate the at least one digital pass, the at least one digital pass deployable by the one or more network devices.

One embodiment of the digital pass system provides at least one further user interface screen to allow the at least one user to sign up to receive credentials, log in to an associated dashboard, the dashboard designed to allow at least one or more of create a new digital pass, edit a digital pass, configure a digital pass, design a digital pass, deploy a digital pass, distribute a digital pass, use digital pass features, send messages to digital pass holders, track and measure digital pass campaigns, apply a code to a digital pass, send a bill, and pay a bill.

One embodiment of the digital pass system includes user vectors wherein the user vector of the at least one user further determines if, when, to whom and what information is sent.

One embodiment of the digital pass system maps pathways around obstacles within the spatial element of the promotional environment from which to calculate travel distances greater than direct distances.

One embodiment of the digital pass system provides at least one or more of a pass store wherein users can find, present, and transact digital passes, an ad network wherein users are presented with localized advertising, and a pass marketplace wherein users may find, present, and incorporate features into the digital pass.

One embodiment of the digital pass system includes a bidirectional capability wherein the at least one user can respond to information sent and an associated call to action.

One embodiment of the digital pass system includes at least one identifier for the at least one user from which the digital pass system is designed to collect data, the at least one identifier set apart from user-provided identity information.

The inventive concept now will be described more fully hereinafter with reference to the accompanying drawings, which are intended to be read in conjunction with both this summary, the detailed description and any preferred and/or particular embodiments specifically discussed or otherwise disclosed. Inventive concepts may, however, be embodied in many different forms and should not be construed as limited to the embodiments set forth herein; rather, these embodiments are provided by way of illustration only and so that this disclosure will be thorough, complete, and will fully convey the full scope of the inventive concepts to those skilled in the art.

### BRIEF DESCRIPTION OF THE DRAWINGS

FIG. 1 illustrates one representative embodiment of the digital pass system.

FIG. 2 illustrates a digital pass portal and digital pass.

FIG. 3 illustrates a network interface assembly.

FIG. 4 illustrates the representative embodiment of the digital pass system within a geofencing system.

FIG. 5 illustrates a representative promotional environment as a mall installation of the digital pass system.

FIG. 6 illustrates scanning and tapping an optical code, a computer link, and an NFC tag.

FIGS. 7A-7D illustrates a representative method for using the digital pass system.

FIG. 8 illustrates another representative embodiment of the digital pass system within a geofencing system.

FIG. 9 illustrates a pass store, an ad network, and a pass marketplace.

FIGS. 10A-10J illustrate a representative set of screens for the user interface including, but not limited to, creating, selecting, configuring, designing, and deploying a digital pass.

FIGS. 11A-1111 illustrate a representative set of screens for the network interface assembly including, but not limited to, message pass holders, administrate beacon and geo-fencing parameters, manage passholders and engagements, manage pass barcoding, and administer pass barcodes.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

Disclosed is a digital pass system and digital pass method designed to allow people via at least one computerized device to opt in to receive electronic messages, such as product promotions or information, without requiring people to submit or allowing access to their personal information. The digital pass system and method selects when to present messages based on at least one or more of: 1) spatial variables, such as the proximity of people to a promoting enterprise via Bluetooth and geofencing technologies; 2) temporal considerations, such as the optimal time window for a promotion; 3) material considerations, such as what products are to be promoted; and, 4) and risk considerations, such as considering the number of people within a spatial and temporal limit who would likely produce the intended result of a promotion without creating too much or too little demand. Material can be a tangible item such as a product and may also be an intangible item such as a service or a virtual item. The inventive concept may operate entirely in virtual space as represented by Facebook Meta or other virtual environments.

The digital pass system can be added to the mobile computerized device by such ways as electronic search and scanning optical codes such as QR codes, through hyperlinks, or by tapping an NFC tag. Through the digital pass system, the user permits the digital pass system to detect the user's presence by such ways, though not limited to, geofencing, Bluetooth beacon, or other signals from the at least one mobile computerized device the digital pass system further calculating velocity information as may be important to determine which message to send, for example, a welcome message if the user is approaching and a message designed to bring the user back of the user is departing. Geofencing in a virtual environment may be geofencing around a given virtual space such as a virtual store or virtual community.

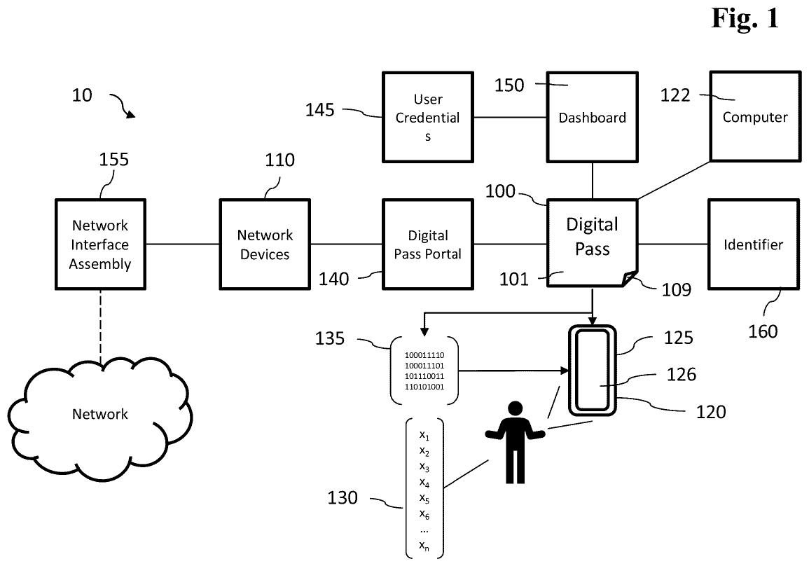

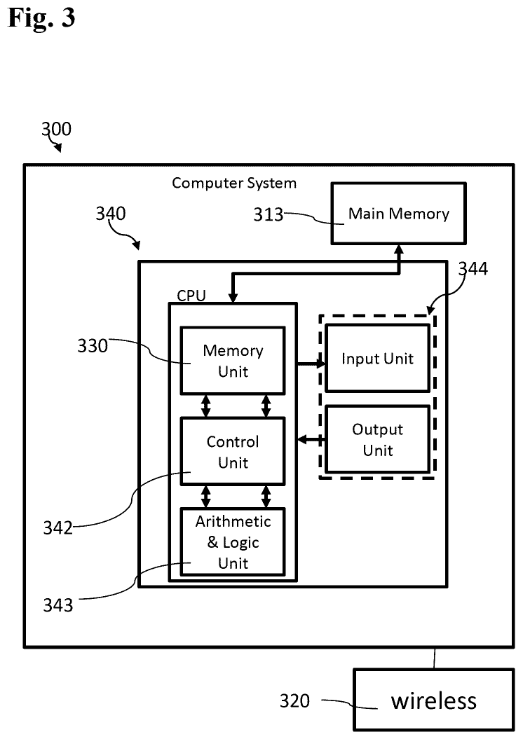

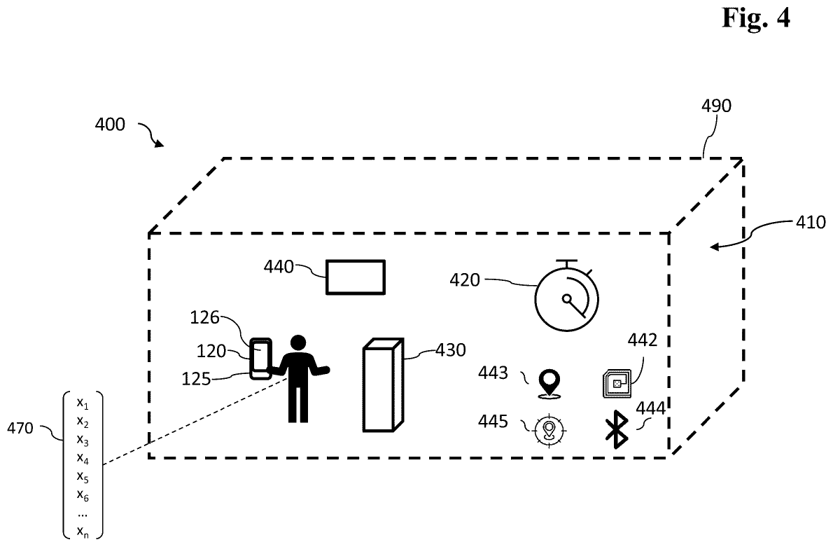

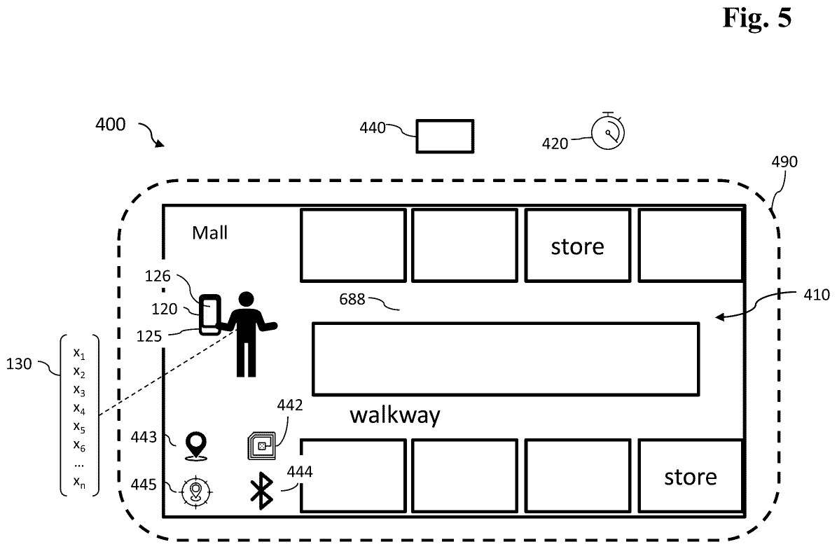

Referring to FIGS. 1-6, FIG. 1 illustrates one representative embodiment of the digital pass system 10 where a network interface assembly 155 includes one or more network devices 110. At least one control circuit assembly 340, as illustrated in FIG. 3, is designed to receive and transmit information via the network interface assembly 155. As illustrated in FIG. 4, a promotional environment 400 for the digital pass system 10 is designed to contain at least one user, the user detected from the user's at least one mobile computerized device 120. A mobile computerized device 120 is typically a smartphone but may also be such devices as a smartwatch, tablet, or a personal computer such as a laptop. The user is further able to retain personal identity information when interfacing with a given promotional environment 400 supported by a given digital pass system 10, promotional environments 400 having at least one or more of a spatial element 410, a temporal element 420, a material element 430, and a risk element 440, the risk element 440 designed to calculate outcome probabilities. Promotional environments 400, for illustration, could be a mall, as illustrated in FIG. 5, or a shopping district of a municipality where a cluster of stores may collectively create an attractive shopping area for customers while at the same time competing for attention for their store. To further illustrate, a restauranteur may use the disclosed inventive concept to encourage people to select their restaurant within a given promotional environment 400 when those people otherwise have many restaurants from which to choose. At least one or more of an NFC tag 442, global positioning system (GPS) 443, a Bluetooth beacon assembly 444, and a geofencing system 445 is designed for determining the presence of the at least one user. Users are individual people but also may be groups of people such as a family or members of an organization.

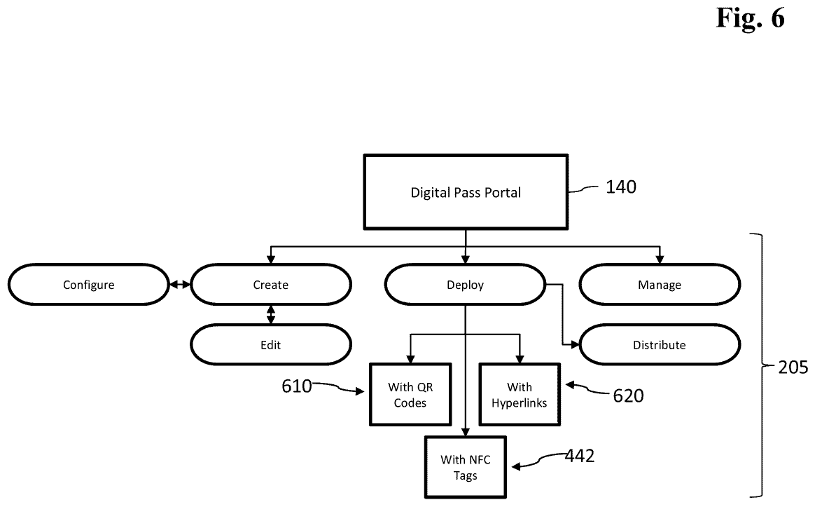

Included, as illustrated in FIG. 1, is at least one user interface 125 of the mobile computerized device 120 wherein the at least one user may create through a digital pass portal 140 at least one digital pass 100 on at least one computerized device 122 is designed to accept receipt of at least one or more of information, coupons, and transactions via the network interface assembly 155, the user interface 125 disposed on the at least one mobile computerized device 120 designed to receive user initiation by at least one or more of, as illustrated in FIG. 6, scanning and tapping an optical code 610, a computer link 620, and an NFC tag 442. Each digital pass 100 may have a front side 101 and a backside 109 that contains different information, coupons, and transactions. The at least one computerized device 122 may be the at least one mobile computerized device 120. In some embodiments, the at least one computerized device 122 may present a QR code that may be scanned from a screen of the given computerized device 122 by a given mobile computerized device 120.

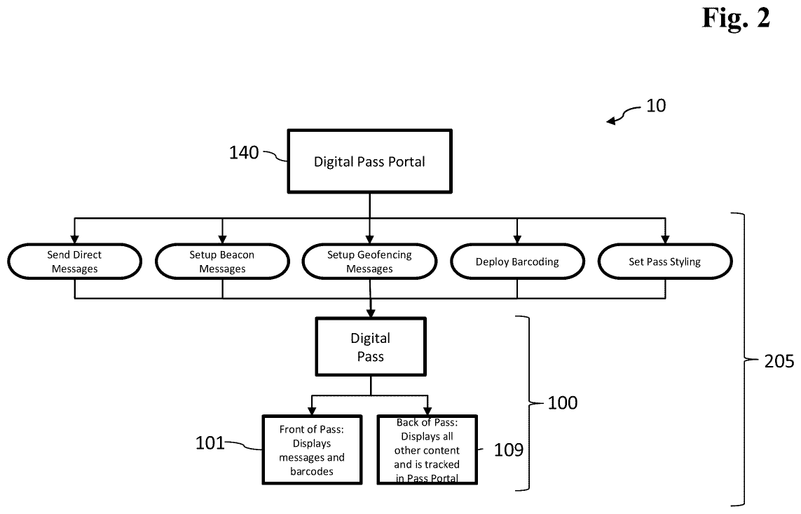

FIG. 1 further illustrates that the at least one mobile computerized device 120 is designed to register at least one push notification service to provide a unique, secure, and randomized token 135 into the digital pass 100 wherein, as illustrated in FIG. 2, digital pass software 205 can determining if, when, and to whom to send information via the network interface assembly 155. The network interface assembly 155 is designed to send information to the at least one digital pass 100 as prompted by the digital pass software 205 based on at least one or more of the location of the at least one user, the time, the material associated with the information, and the probability the at least one user will respond to information positively, the probability further determined by at least one or more of past behavior statistics data and predictive algorithms, the predictive algorithms further designed to use data the user has permitted the digital pass software 205 to receive. The network interface assembly 155 may send information, coupons, and transaction substantially in real time though some delay may be permitted. The digital pass system 10 further tracks statistics of how many adds, how many messages were received by the consumer, and how much engagement transpired, to include, but not be limited by, phone calls, emails, texts, and link clicks.

The at least one user can initiate the receipt of at least one or more of information, coupons, and transactions by at least one or more of moving within the promotional environment 400 and sending a request for a digital pass 100. The boundaries of a given promotional environment 400 for a given user may be variable and may be predictive, for illustration, sending a digital pass 100 to a user outside the geo-fenced boundary 490 based on the probability the given user will enter a geo-fenced area instead of waiting until that given user enters the geo-fenced boundary 490.

FIG. 1 further illustrates that in the representative embodiment, the digital pass system 10 further has at least one user interface screen 126 through which the at least one user selects from at least one type of digital pass 100, chooses from at least one action for the digital pass 100, configures the at least one digital pass 100, designs the at least one digital pass 100, and activates the at least one digital pass 100, the at least one digital pass 100 deployable by the one or more network devices 110.

FIG. 1. further illustrates that in the representative embodiment, the digital pass system 10 may include at least one interface screen 206 of the user interface 205 wherein the at least one user can sign up to receive credentials 145, log in to an associated dashboard 150, the dashboard 150 designed to allow at least one or more of creating a new digital pass 100, editing the digital pass 100, configuring the digital pass 100, deploying the digital pass 100, distributing the digital pass 100, using the features of the digital pass 100. People providing the at least one digital pass 100 can use the network interface assembly 155 leading to the digital portal 140 for sending messages to holders of digital passes, tracking and measuring digital pass campaigns, applying a code to the digital pass 100, sending a bill, and paying a bill.

FIG. 1 further illustrates that the representative embodiment of the digital pass system 10 may include user vectors 130 wherein the user vectors 130 of the at least one user further determines if, when, to whom and what information is sent. A user vector 130 is a representation of a user from which the digital pass system 10 can select actions to take based on how well the vector 130 matches given criterion. Ratings on a given criterion may be assigned as one or more variables to create the vector 130. The representative embodiment of the digital pass system 10 may further include within user vectors 130 directional information further mapped to pathways 688, as presented in a mall viewpoint of FIG. 6, which may include pathways 688 around obstacles within the spatial element 410 of the promotional environment 400 from which to calculate travel distances.

FIG. 4 illustrates that the representative embodiment of the digital pass system 10 may further include at least one or more of NFC tags 442, GPS 443, a Bluetooth beacon assembly 444, and a geofencing system 445, each designed for determining the location of the at least one user. One representative embodiment of the digital pass system 10 supports locational messages that work from 10 feet to 3,280 feet. One representative embodiment of the digital pass system 10 supports beacon messages that work from 0.25 feet to 35 feet. Other embodiments may have different ranges. In some embodiments of the digital pass system 10 support unlimited geo locations which may be located outside supported stores within the represented ranges.

FIG. 1 further illustrates that the representative embodiment of the digital pass system 10 may further include a bidirectional capability wherein the at least one user can respond to information sent and an associated call to action from that information. The representative embodiment of the digital pass system 10 may further include at least one identifier 160 for the at least one user from which the digital pass system 10 is designed to collect data, the at least one identifier 160 set apart from user-provided identity information.

FIG. 2 illustrates the digital pass software 205 and representative actions that can be taken wherein the digital pass 100 is created through the digital portal 140. The digital pass software 205 is not limited to the representative actions, and these are illustrations of one representative embodiment of the digital pass system 10.

FIG. 3 illustrates the at least one computer system 300 designed to receive and transmit information via the network interface assembly 320. FIG. 3 further illustrates an at least one control circuit assembly 340 wherein the control circuit assembly 340 comprises a volatile memory storing a set of one or more computer-readable interactions executable by the control circuit assembly 340. Further included are at least one input and output units 344, main memory 313, memory units 330, control units 342, and arithmetic and logic units 343 as required for digital pass system 10 operations.

FIGS. 1 and 3, illustrate that the network interface assembly 155 may have one or more network devices 110 configured to allow the control circuit assembly 340 to receive and transmit information via a wireless network interface assembly 320. In some embodiments, the network interface assembly 155 may have one or more of a network modem, a router, data port, and transceiver assembly. The wireless network interface assembly 320 may have the network interface assembly 155 configured to allow the exchange of data. In some embodiments, the network interface assembly 320 may have one or more of the Internet, a local area network, a private network, a virtual private network, a home network, a wired network, and the wireless network interface assembly 320.

FIG. 5 illustrates a representative mall installation as a promotional environment 400 which, in this representative illustration, is encompassed by the geofencing system 445, and also illustrates NFC tags 442, global positioning system 443, a Bluetooth beacon assembly 444. The representative promotional environment 400 has at least one or more of the spatial element 410, the temporal element 420, the material element 430, and the risk element 440, the risk element designed to calculate outcome probabilities.

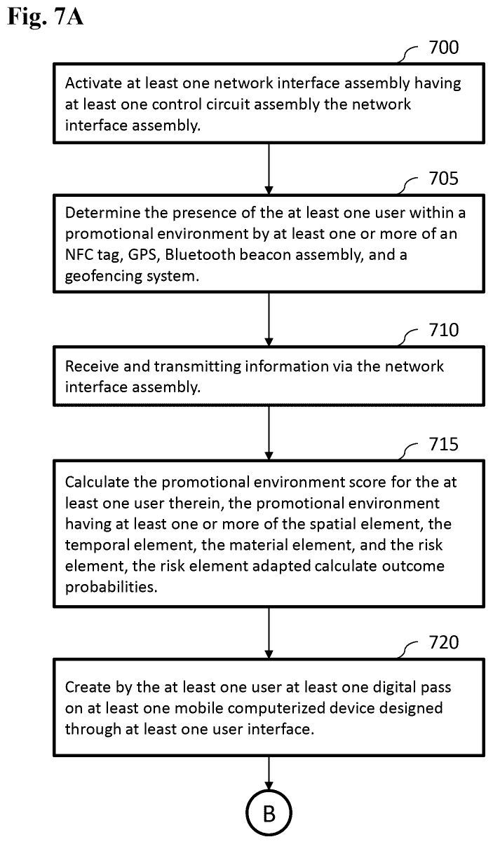

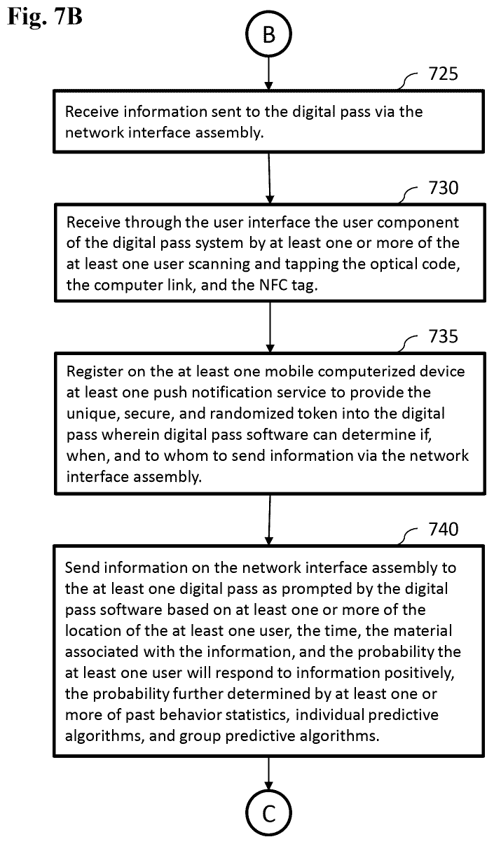

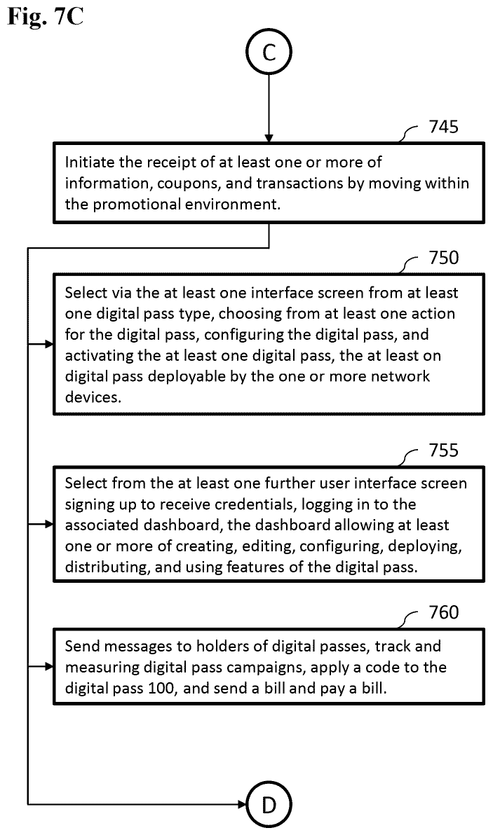

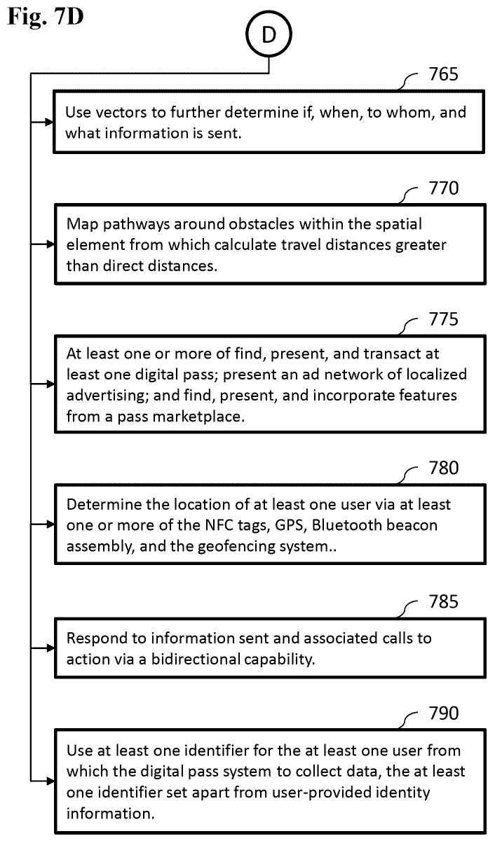

FIGS. 7A-7D illustrate a representative method for using the digital pass system 10, the method including the step of 700, activating at least one network interface assembly 155 having at least one control circuit assembly 340 for the network interface assembly 155. The method further includes the step of 705 determining the presence of the at least one user within a promotional environment 400 by at least one or more of an NFC tag 442, global positioning system 443, Bluetooth beacon assembly 444, and a geofencing system 445.

The method further includes the step of 710, receiving and transmitting information via the network interface assembly 155. The method further includes the step of 715 calculating a score for the given promotional environment 400 for the at least one user therein, which in the representative environment creates the at least one vector 130, the promotional environment 400 having at least one or more of the spatial element 410, the temporal element 420, the material element 430, and the risk element 440, the risk element designed to calculate outcome probabilities.

FIGS. 7A-7D illustrate that the representative method for using the digital pass system 10 further includes the step of 720, creating through the digital pass portal 140 by the at least one user at least one digital pass 100 on at least one mobile computerized device 120 designed through at least one user interface 125. The method further includes the step of 725, receiving information sent to the digital pass 100 via the network interface assembly. The method further includes the step of 730 the user interface 125 receiving the user component of the digital pass software 205 by at least one or more of the at least one user scanning and tapping the optical code 610, the computer link 620, and the NFC tag 442. The method further includes the step of 735 registering on the at least one mobile computerized device 120 at least one push notification service to provide the unique, secure, and randomized token 135 into the digital pass 100 wherein digital pass software 205 can determine if, when, and to whom to send information via the network interface assembly 155.

FIGS. 7A-7D further illustrate that the representative method for using the digital pass system 10 includes the step of 740, sending information on the network interface assembly to the at least one digital pass 100 as prompted by the digital pass software 205 based on at least one or more of the location of the at least one user, the time, the material associated with the information, and the probability the at least one user will respond to information positively, the probability further determined by at least one or more of past behavior statistics, individual predictive algorithms, and group predictive algorithms. The method further includes the step of 745, the at least one user initiating the receipt of at least one or more of information, coupons, and transactions by moving within the promotional environment 400.

FIGS. 7A-7D further illustrate that the representative method may further include the step of 750, at least one user selecting via the at least one user interface 125 from at least one digital pass 100 type, choosing from at least one action for the digital pass 100, configuring the digital pass 100, and activating the at least one digital pass 100, the at least one digital pass 100 deployable by the one or more network devices 110.

FIGS. 7A-7D illustrate that the representative method may further include the step of 755 the at least one user selecting from the at least one further user interface screen 126 signing up to receive credentials 145, logging in to the associated dashboard 150, the dashboard 150 allowing at least one or more of creating, editing, configuring, deploying, distributing, and using features of the digital pass 10. FIGS. 7A-7D illustrate that the representative method may further include the step of 760, sending messages to holders of digital passes, tracking and measuring digital pass 100 campaigns, applying a code to the digital pass 100, and sending a bill and paying a bill.

FIGS. 7A-7D illustrate that the representative method may further include the step of 765, using vectors 130 to further determine if, when, to whom and what information is send.

FIGS. 7A-7D illustrate that the representative method may further include the step of 770, mapping pathways around obstacles within the spatial element 410 from which to calculate travel distances greater than direct distances.

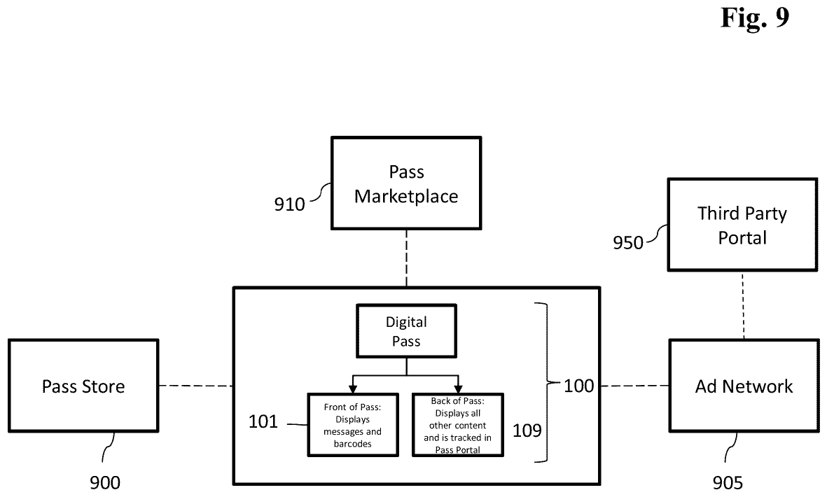

FIGS. 7A-7D further illustrate that the representative method may further include the step of 775 at least one or more of finding, presenting, and transacting from, as illustrated in FIG. 9, at least one pass store 900 at least one digital pass 100, presenting an ad network localized advertising from an ad network 905, and finding, presenting, and incorporating features from a pass marketplace 910.

FIGS. 7A-7D further illustrate that the representative method may further include the step of 780, determining the location of at least one user via at least one or more of the NFC tags 442, global positioning system 443, Bluetooth beacon assembly 444, and the geofencing system 445.

FIGS. 7A-7D illustrate that the representative method may further include the step of 785, responding to information sent and associated calls to action via a bidirectional capability.

FIGS. 7A-7D illustrate that the representative method may further include the step of 790, using at least one identifier 160 for the at least one user from which the digital pass system 10 to collect data, the at least one identifier 160 set apart from user-provided identity information.

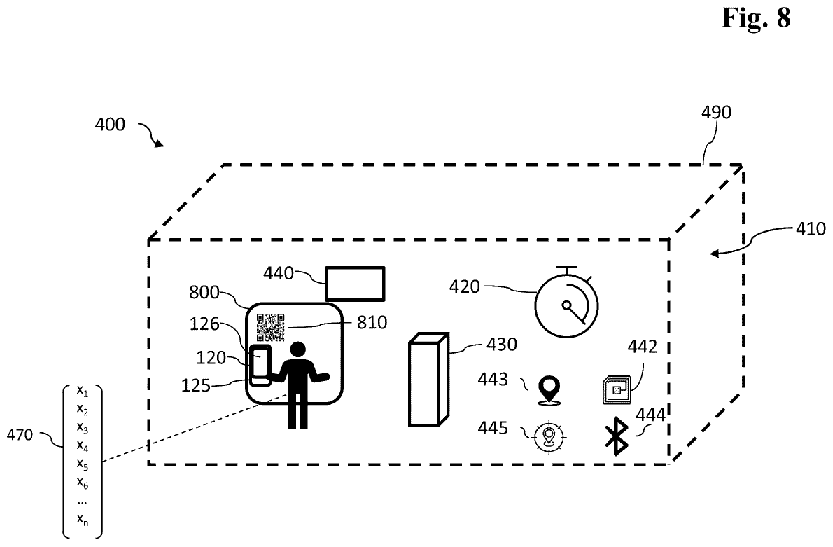

FIG. 8 illustrates that another representative embodiment of the digital pass system 10 includes the network interface assembly 155 having the one or more network devices 110, the at least one control circuit assembly 340 designed to receive and transmit information via the network interface assembly 155. A promotional interface 800 is designed to communicate with at least one user, the user initiating the communication from at least one mobile computerized device 120, the user further able to retain personal identity information when interfacing the promotional interface. This representative embodiment includes the at least one user interface 125 wherein the at least one user may create with the digital pass portal 140 the at least one digital pass 100 on the at least one computerized device 122 designed to accept receipt of at least one or more of information, coupons, and transactions via the network interface assembly, the user interface 125 disposed on the at least one mobile computerized device 120 designed to receive the user component of the digital pass system 10 by at least one or more of scanning and tapping the optical code 610, the computer link 620, and the NFC tag 442.

The at least one mobile computerized device 120 is designed to register the at least one push notification service to provide the unique, secure, and randomized token 135 into the digital pass 100 wherein digital pass software 205 can determining if, when, and to whom to send information via the network interface assembly 155. The network interface assembly 155 sending information to the at least one digital pass 100 as prompted by the digital pass software 205 based on at least one or more of the location of the at least one user, the time, the material associated with the information, and the probability the at least one user will respond to information positively, the probability further determined by at least one or more of past behavior statistics and predictive algorithms, the predictive algorithms further designed to use data the user has permitted the digital pass software 205 to receive. The at least one user initiating the receipt of at least one or more of information, coupons, and transactions by the at least one or more of interfacing with the promotional interface 800 and sending the request for the digital pass 100.

FIG. 8 further illustrates that in this representative embodiment of the digital pass system 10, the promotional interface 800 operates within the promotional environment 400 having at least one or more of the spatial element 410, the temporal element 420, the material element 430, and the risk element 440, the risk element designed to calculate outcome probabilities. In this representative embodiment of the digital pass system 10, the user may interface with at least one QR code 810.

In this representative embodiment of the digital pass system 10, at least one identifier 160 for the at least one user from which the digital pass system 10 is designed to collect data, the at least one identifier 160 set apart from user-provided identity information. In some embodiments, the user may, at the user's discretion, provide identity information. Identity information, in such embodiments, is stored in a secure data pass and allows the digital pass 100 to become a unique asset per user, depending on how the digital pass 100 has been configured.

Once a given digital pass 100 is added to a given user's mobile computerized device 120, in some embodiments within a digital wallet, the digital pass 100 can be the automatic information system based on 1) the spatial context of that user and 2) as the user engages with locations issuers may have set up. The given user does not have to do anything more than move around and new experiences can emerge automatically using that digital pass 100. Spatial examples include but are not limited to: 1) NFC tags 442, which enable notifications when tapping the tag with the user's mobile computerized device about 0-2 inches from at least one portion of the network interface assembly; 2) Bluetooth beacons 444, which enable notifications within approaching within about 1-33 feet of at least one portion of the network interface assembly; and 3) Geofencing addresses 443, which enabling notifications within about 34 feet-3280 feet from at least one portion of the network interface assembly. How engagement takes place includes receiving information, seeking information, gaining perspective on from information, making decisions from information, taking actions on information, and assessing results of information use.

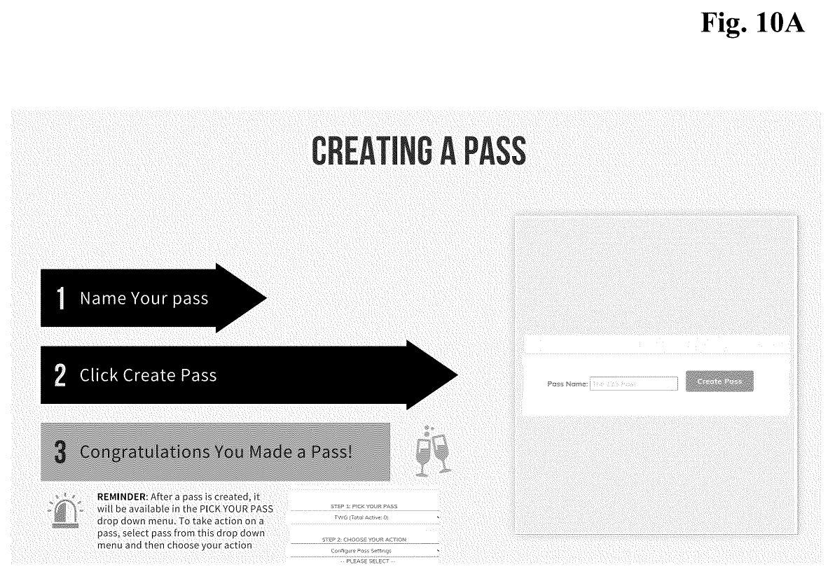

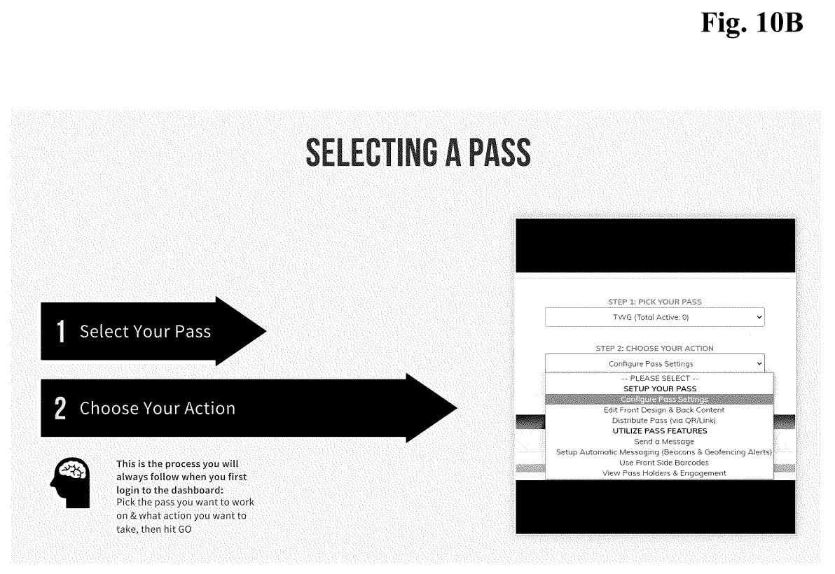

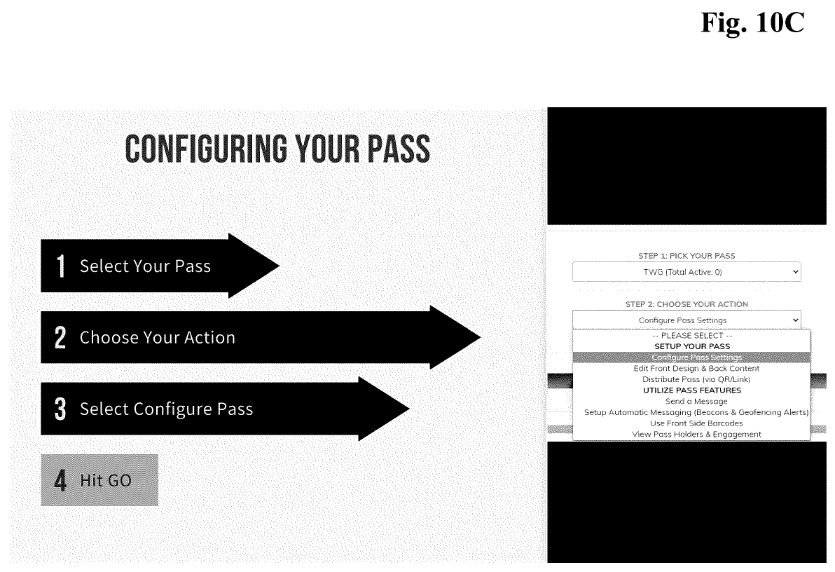

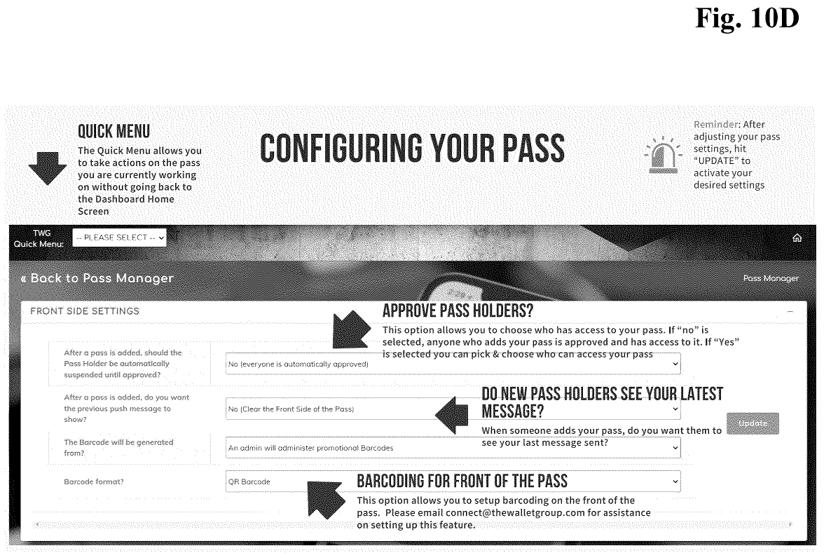

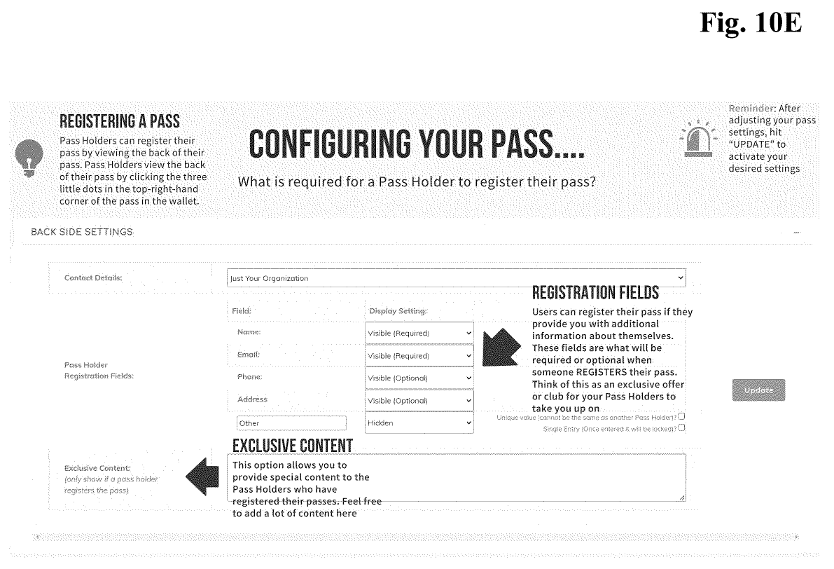

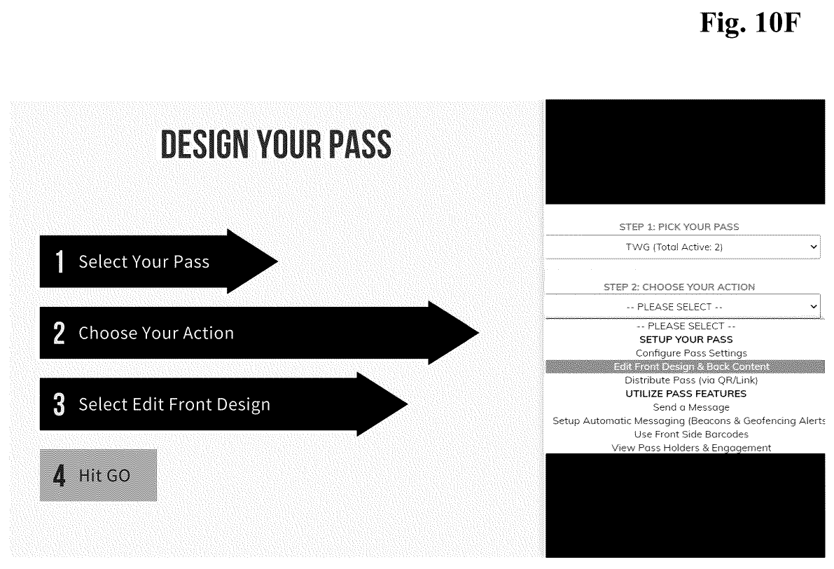

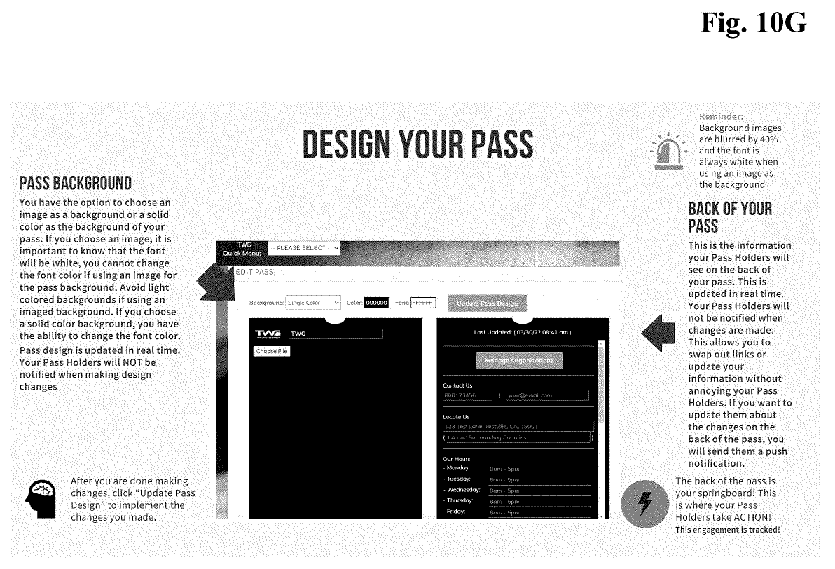

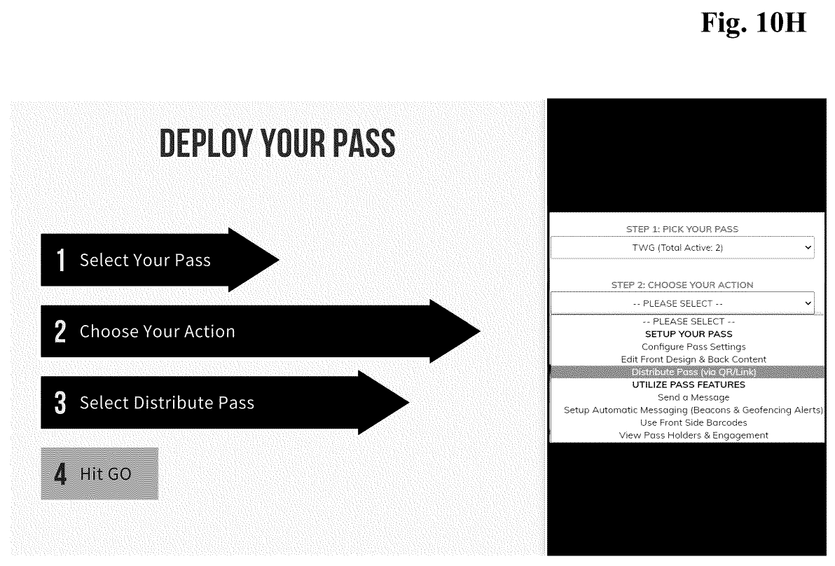

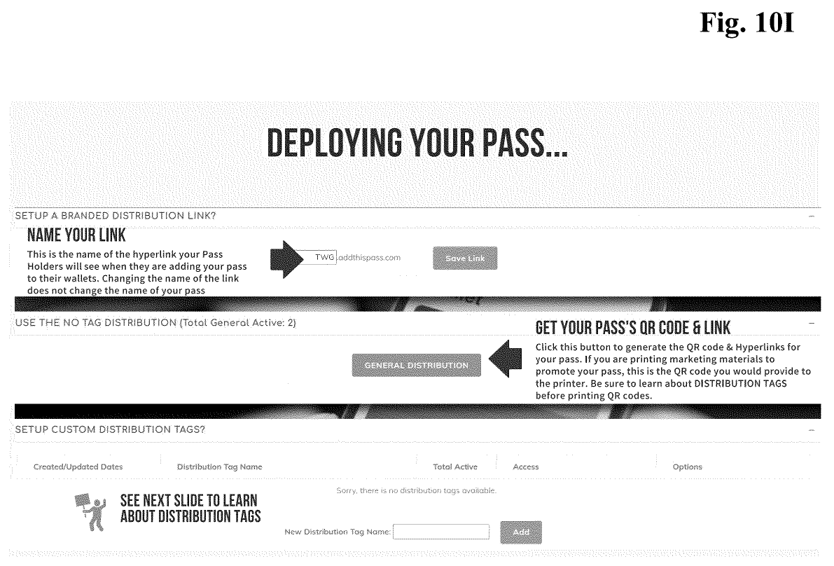

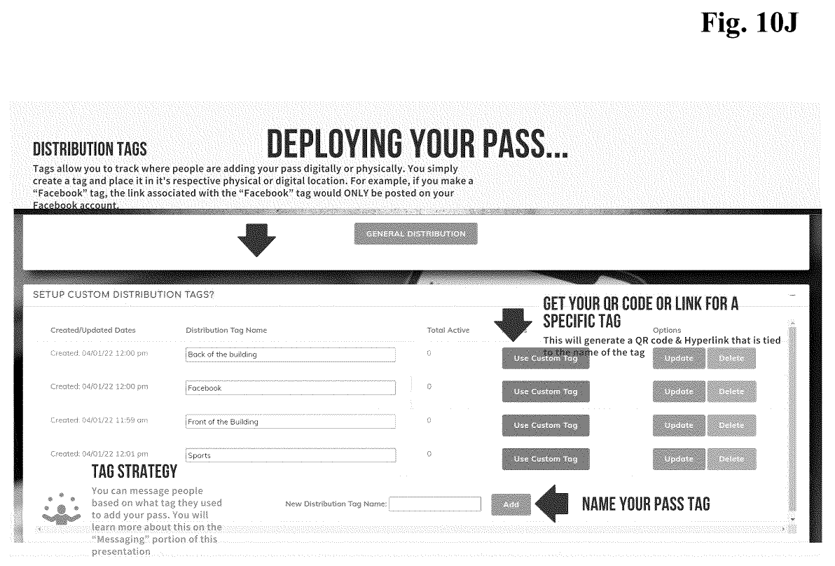

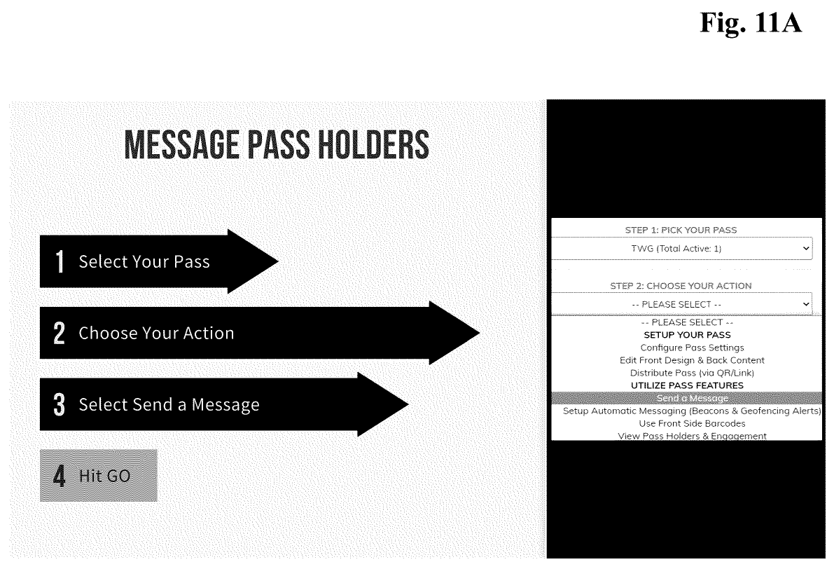

In representative embodiments of the digital pass system 10, the digital pass 100 can be registered. In this embodiment, the at least one user registers the given digital pass 100 by accessing the backside of the digital pass 109, as illustrated in FIG. 2, and clicking “Register this digital pass”. The creator of the digital pass 100 determines what information is required to register the digital pass 100. In exemplary embodiments, the digital pass creator can require name, email, address to register the digital pass 100. The issuer of the digital pass 100 can also request whatever additional information from the at least one user if the at least one user wants to register. A front of the digital pass 101 may display such information as messages and barcodes Registration is an exchange of information between the given holder (user) of the digital pass 100 and the organization (creator) of the digital pass 100 for exclusivity, validation, and/or promotional purposes. The given user of the digital pass 100 typically gives information in exchange for something. Representative screen shots appear in FIGS. 10A-10J, and FIGS. 11A-1111.

In one representative embodiments of the digital pass system 10, the criterion for issuing and redeeming the digital pass 100 can change depending upon whether previous results are greater or lesser than forecasted to raise or lower the likelihood of further action taken on the give digital pass 100. For one representative illustration, if the seats at a venue that are accessible via the digital pass 100 are not being filled, additional messages can be sent to users presenting a better offer. If the seats are filled, messages can be erased from the at least one user's digital pass 100, assuring that no one can take up the offer after quantities have been filled.

In representative embodiments of the digital pass assembly 10, the at least one user can observe another holder of the digital pass 100 using the promotion that was delivered to the digital pass 100 and be reminded to use the promotion on the digital pass 100. Also, if the issuer of the digital pass 100 is changed, the notifications relative to the capacity of the offer (10 seats left, 9 now left, etc.), then users redeeming offers potentially create the scarcity situation driving competition for the redemption before the offer expires or is termed.

Representative embodiments of the digital pass system 10 have engagement tracking. The digital pass system 10 knows how many users received notifications or engage with offer links or phone numbers. Historical data can be reviewed to determine the success of information and promotion. The digital pass system 10 can further compute the total number of people to which an offer was sent to that of redemption to determine return on investment (ROI). The digital pass system 10 can further be used in simulations for predictive modeling on significant ROI notification offers.

FIG. 9 illustrates that one representative embodiment of the digital pass system provides at least one or more of a pass store 900, wherein users can find, present, and transact digital passes, an ad network 905 wherein users are presented with localized advertising, and a pass marketplace 910 wherein users may find, present, and incorporate features into the digital pass 10. The pass store 900 is substantially an app store wherein people can search for specific categories and brands of digital passes 100 and offer types and be shown relative digital passes 100 that would be appropriate to add to their digital wallet. The ad network 905 holds one digital passes 100 that could reveal localized and relevant ads. For illustration, if a user adds the user's child's high school to the user's digital wallet, the back side of the digital pass 109 might have an ad present for a local pizza shop next to the school that offers 50% off to all students with a clickable link. A third-party portal 950 may be present for third party advertisers such as the representative pizza shop that can identify the type of consumer they are looking for and pay to have their advertisement served up into digital passes 10 for those appropriate consumers.

The back of any digital pass 109 may contain brand information and may also serve as a springboard for user engagement. Issuers can look up a feature they want to add to their given digital pass 100, for illustration, a loyalty program. Users can search for this or any other features introduced to the pass marketplace 910 and activate the feature as a paid subscription in their digital pass 100. Representative categories include, but are not limited to, loyalty, rewards, and commerce, and the issuer, typically a brand, can choose which of these modules to activate depending on their use and how robust they want their digital pass 100 to be.

FIGS. 10A-10J illustrate a representative set of screens for the user interface 125 including, but not limited to, creating, selecting, configuring, designing, and deploying a digital pass 100.

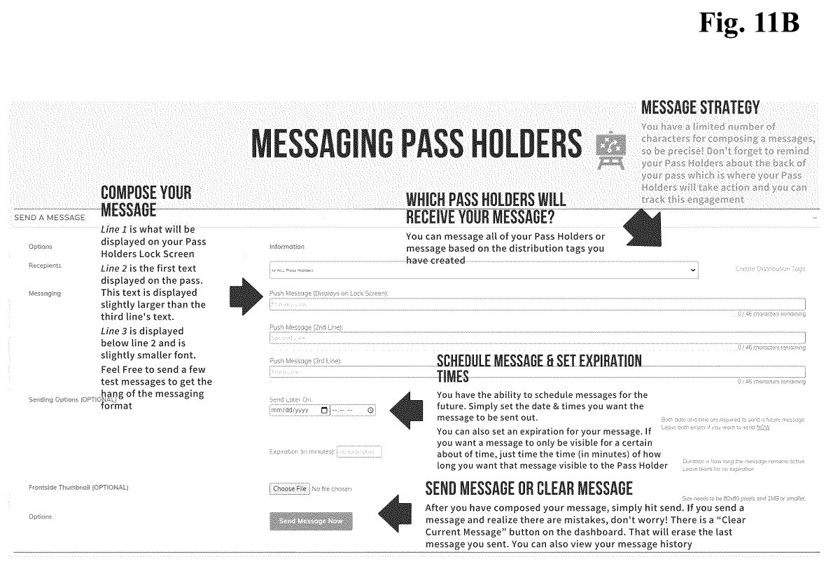

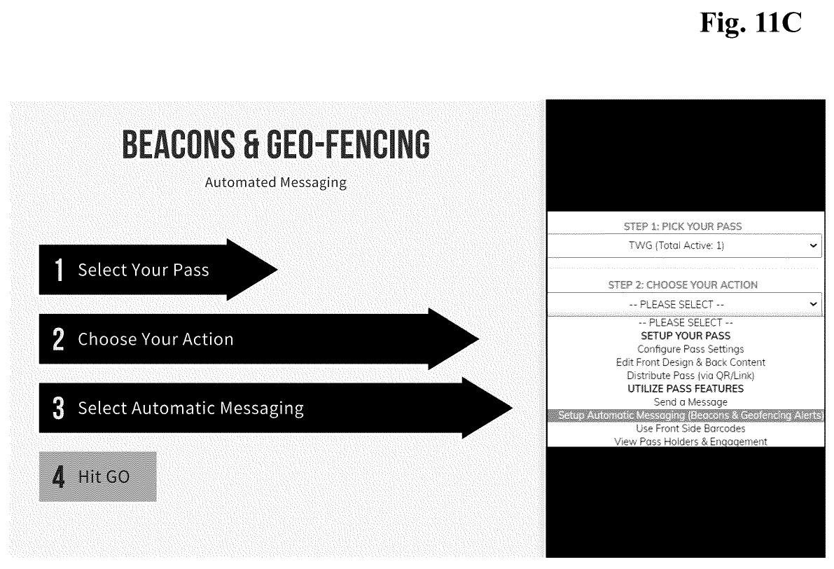

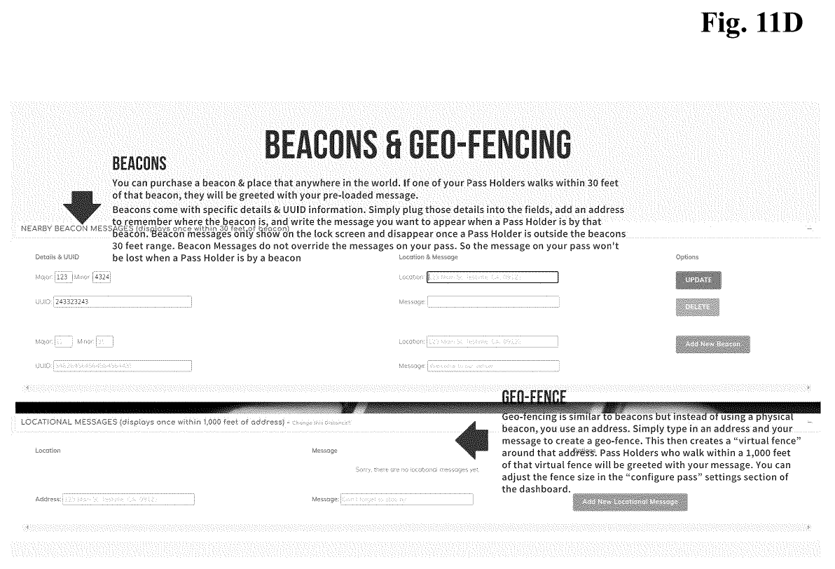

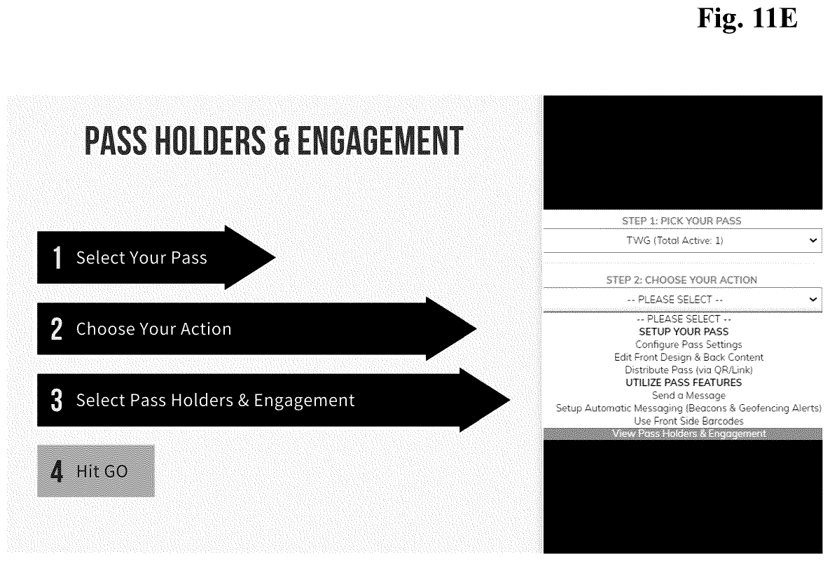

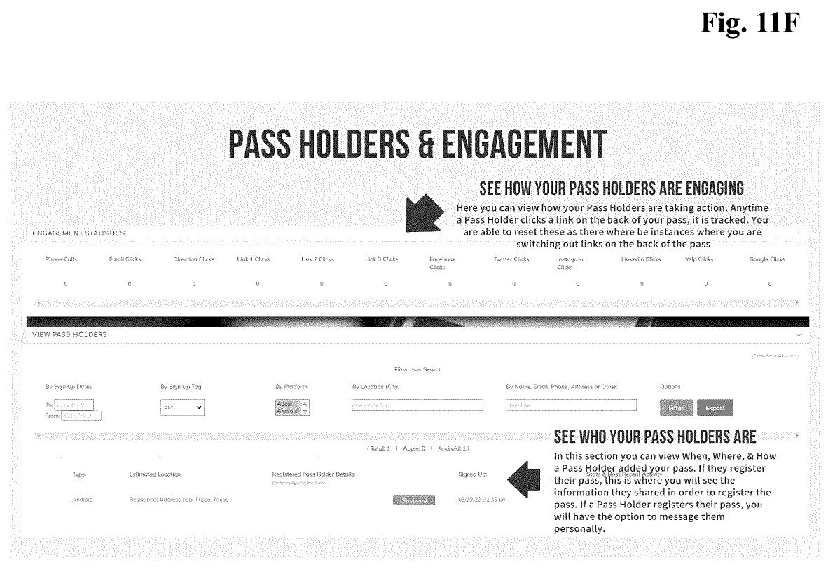

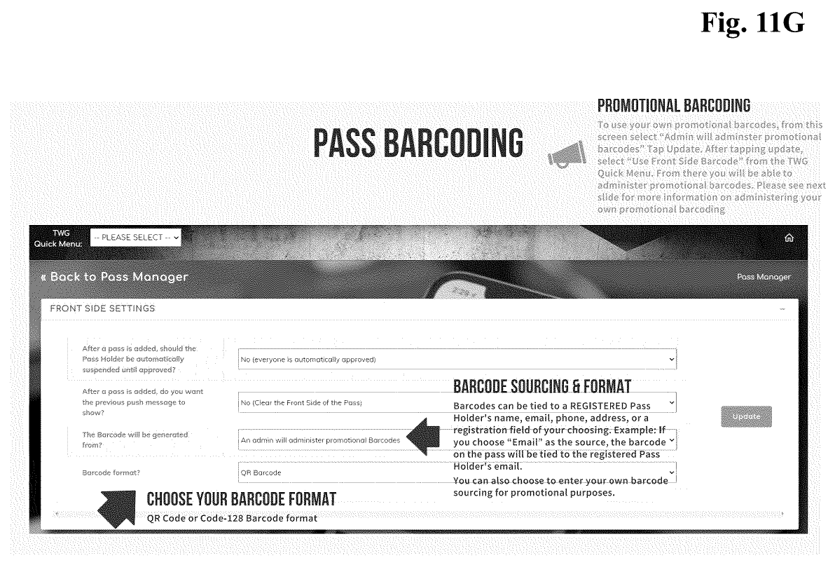

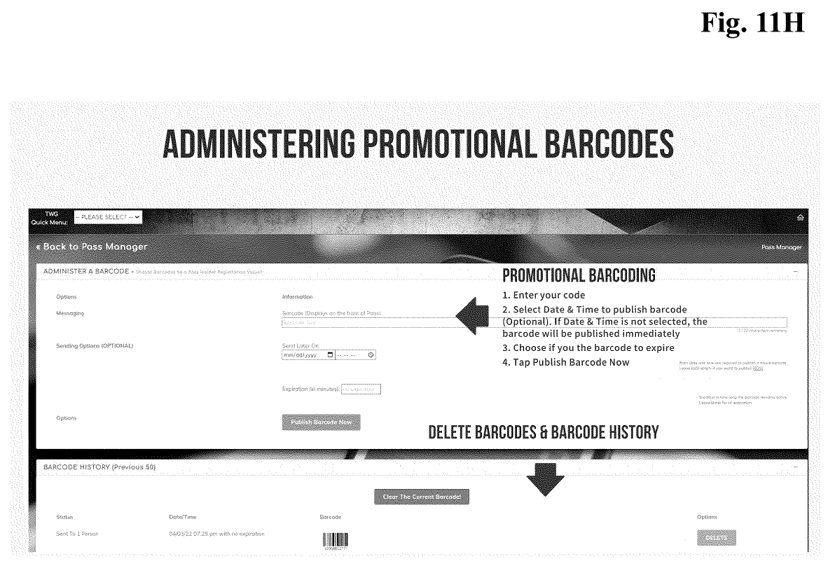

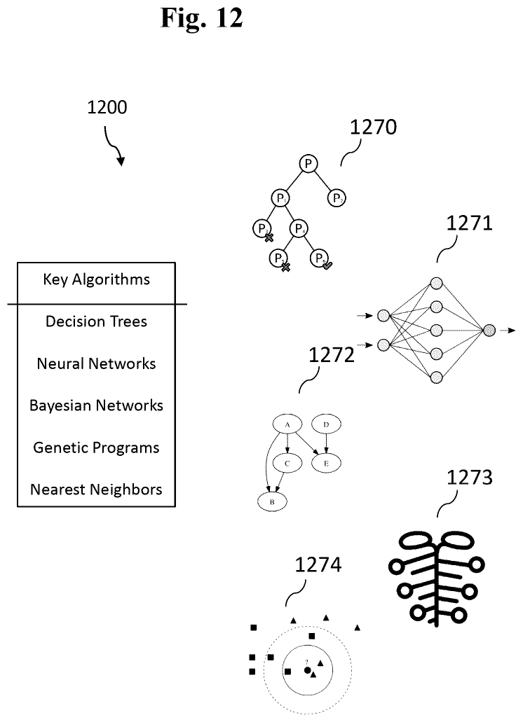

FIGS. 11A-1111 illustrate a representative set of screens for the network interface assembly 155 including, but not limited to, message pass holder, administrate beacon and geo-fencing parameters, manage passholders and engagements, manage pass barcoding, and administer pass barcodes.

FIG. 12 illustrates the digital pass system 10 may employ machine learning algorithms 1200 via one or more machine learning software systems from a group of: decision trees 1270, neural networks 1271, Bayesian networks 1272, genetic programs 1273, and nearest neighbor 474. Data from the digital pass system 10 may further be processed through machine learning algorithms 1200 to improve upon the algorithm used to select the who, what, when, where, why, and how behind a promotion along with assigning at least one identifier for each given user from which the digital pass system 10 improves at providing relevant messages to that given user. The scope of the spatial variables, the temporal variables, and the material variables may be absolute limits of a screening consideration, such as only including users within one hundred meters of the store, or limits of a screening consideration may be allowed to vary, for example, the digital pass system selecting a user where the maximum acceptable distance away a given user could be to receive a given message correlates to the probability that the given user would act on the promotion. In this latter instance, therefore, the digital pass system 10 could allow the conditions where one user may receive a message pertinent to that user while another user closer to the promoted materials receives no message.

The following patents are incorporated by reference in their entireties: Pat. Nos. U.S. Pat. No. 4,103,807B2, U.S. Pat. No. 4,282,849B2, U.S. Pat. No. 4,684,047B2, U.S. Pat. No. 4,705,015B2, U.S. Pat. No. 5,038,987B2, U.S. Pat. No. 5,165,584B2, U.S. Pat. No. 5,243,957B2, U.S. Pat. No. 5,243,959B2, U.S. Pat. No. 5,246,154B2, U.S. Pat. Nos. 5,497,512, 6,591,825B2, U.S. Pat. No. 6,948,690B2, U.S. Pat. No. 7,290,689B2, U.S. Pat. No. 7,527,182B2, U.S. Pat. No. 7,798,137B2, U.S. Pat. No. 8,161,956B2, U.S. Pat. No. 8,336,746B2, U.S. Pat. No. 8,814,018B2, U.S. Pat. No. 8,899,217B2, U.S. Ser. No. 11/009,308B2, US20120043362A1, and US20220082350A1.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

1. A digital pass system comprising:
a network interface assembly having one or more network devices;
at least one control circuit assembly adapted to receive and transmit information via the network interface assembly;
a promotional environment adapted to contain at least one user, the user detected from at least one mobile computerized device, the user further able to retain personal identity information when interfacing the promotional environment, the promotional environment having at least one or more of a proximity spatial element, a time window temporal element, a products material element, and a risk element, the risk element adapted to calculate outcome probabilities from the at least one user;
at least one or more of an NFC tag adapted to detect the user's mobile computerized device about 0-2 inches from at least one portion of the network interface assembly, global positioning system, a Bluetooth beacon assembly adapted to enable notifications of user approaches within about 1-33 feet of at least one portion of the network interface assembly, and a geofencing system adapted for determining the presence of the at least one user within a promotional environment, the promotional environment within 34 to 3,280 feet of promotional message origin, a selected geofence boundary variable for each promotion;
at least one user interface wherein the at least one user may create through a digital pass portal at least one digital pass on at least one computerized device adapted to accept receipt of at least one or more of information, coupons, and transactions via the network interface assembly, the user interface disposed on the at least one computerized device adapted to receive a user component of the digital pass system by at least one or more of scanning and tapping an optical code, a computer link, text, email, and the NFC tag;
the at least one mobile computerized device adapted to register at least one push notification service to provide a unique, secure, and randomized token into the digital pass wherein digital pass software can determining if, when, and to whom to send information via the network interface assembly;
the network interface assembly adapted to send information to the at least one digital pass as prompted by the digital pass software based on at least one or more of a location of the at least one user, a time, a material associated with the information, and a probability the at least one user will respond to information positively, the probability further determined by at least one or more of past behavior statistics data and predictive algorithms from at least one or more from a group of: decision trees, neural networks, Bayesian networks, genetic programs, and nearest neighbors, the predictive algorithms further adapted to use data the user has permitted the digital pass software to receive, wherein assigning at least one identifier for each given user from which the digital pass system improves at providing relevant messages to that given user;
user vectors from the data, user location, and user trajectory, wherein the user vector of the at least one user further determines if, when, to whom and what information is sent;
the at least one user initiating the receipt of at least one or more of information, coupons, and transactions by at least one or more of moving within the promotional environment and sending a request for a digital pass, the digital pass further adapted to receive messages and have messages erased by way of the control circuit assembly; and
the promotional environment adapted to seek information about the user, gain perspective on that information, make decisions from that information, take action on the information, and assess results of information use.

2. The digital pass system of claim 1 further comprising at least one user interface screen through which the at least one user selects from at least one digital pass type, chooses from at least one action for the digital pass, configures the at least one digital pass, designs the at least one digital pass, and activates the at least one digital pass, the at least one digital pass deployable by the one or more network devices.

3. The digital pass system of claim 1 further comprising at least one further user interface screen adapted to allow the at least one user to sign up to receive credentials, log in to an associated dashboard, the dashboard designed to allow at least one or more of create a new digital pass, edit a digital pass, configure, a digital pass, design a digital pass, deploy a digital pass, distribute a digital pass, use digital pass features, send messages to digital pass holders, track and measure digital pass campaigns, apply a code to a digital pass, send a bill, and pay a bill.

4. (canceled)

5. The digital pass system of claim 1 further including user travel direction mapped to pathways around obstacles within the spatial element of the promotional environment from which to calculate travel distances.

6. The digital pass system of claim 1 further comprising at least one or more of a pass store wherein users can find, present, and transact digital passes, an ad network wherein users are presented with localized advertising, and a pass marketplace wherein users may find, present, and incorporate features into the digital pass.

7. The digital pass system of claim 1 further comprising a bidirectional capability wherein the at least one user can respond to information sent and an associated call to action.

8. The digital pass system of claim 1 further comprising at least one identifier for the at least one user from which the digital pass system is adapted to collect data, the at least one identifier set apart from user-provided identity information.

9. A digital pass method comprising:
activating at least one network interface assembly comprising at least one control circuit assembly, the network interface assembly receiving and transmitting information via the network interface assembly;
determining a presence of an at least one user within a promotional environment by at least one or more of an NFC tag adapted to detect the user's mobile computerized device about 0-2 inches from at least one portion of the network interface assembly, global positioning system, a Bluetooth beacon assembly adapted to enable notifications of user approaches within about 1-33 feet of at least one portion of the network interface assembly, and a geofencing system; the promotional environment within 10 to 3,280 feet of promotional message origin a selected geofence boundary variable for each promotion;
calculating a promotional environment score for at least one user therein, the promotional environment having at least one or more of a proximity spatial element, a time window temporal element, a product material element, and a risk element, the risk element adapted to calculate outcome probabilities from the at least one user;
creating through a digital pass portal by the at least one user at least one digital pass on at least one computerized device adapted through at least one user interface;
receiving, by the digital pass, information via the network interface assembly;
receiving, by the user interface, a user component of the digital pass system by at least one or more of the at least one user scanning and tapping an optical code, a computer link, text, email, and an NFC tag;
registering on the at least one computerized device at least one push notification service to provide a unique, secure, and randomized token into the digital pass wherein digital pass software can determine if, when, and to whom to send information via the network interface assembly;
sending information on the network interface assembly to the at least one digital pass as prompted by the digital pass software based on at least one or more of the location of an at least one user, a time, a material associated with the information, and a probability the at least one user will respond to information positively, the probability further determined by at least one or more of past behavior statistics data, individual predictive algorithms, and group predictive algorithms, from at least one or more from a group of: decision trees, neural networks, Bayesian networks, genetic programs, and nearest neighbors;
assigning at least one identifier for each given user from which the digital pass system improves at providing relevant messages to that given user;
applying user vectors from the data, user location, and user trajectory, wherein the user vector of the at least one user further determines if, when, to whom and what information is sent; and
the at least one user initiating the receipt of at least one or more of information, coupons, and transactions by moving within the promotional environment, the digital pass at least one or more of receiving or erasing messages; and
seeking with the promotional environment information about the user, gaining perspective on that information, making decisions from that information, taking action on the information, and assessing results of information use.

10. The digital pass method of claim 9, the method further comprising the at least one user selecting via the at least one interface screen from at least one digital pass type, choosing from at least one action for the digital pass, configuring the digital pass, and activating the at least one digital pass, the at least one digital pass deployable by the one or more network devices.

11. The digital pass method of claim 9, the method further comprising the at least one user selecting from an at least one further user interface screen signing up to receive credentials, logging in to an associated dashboard, the dashboard allowing at least one or more of creating a new digital pass, editing a digital pass, configuring a digital pass, deploying a digital pass, distributing a digital pass, using digital pass features, sending messages to digital pass holders, tracking and measuring digital pass campaigns, applying a code to a digital pass, sending a bill, and paying a bill.

12. (canceled)

13. The digital pass method of claim 9, the method further comprising mapping pathways around obstacles within the spatial element from which to calculate travel distances greater than direct distances.

14. The digital pass method of claim 9 further comprising at least one or more of finding, presenting, and transacting at least one digital pass, presenting an ad network localized advertising, and finding, presenting, and incorporating features from a pass marketplace.

15. The digital pass method of claim 9, the method further comprising responding to information sent and associated calls to action via a bidirectional capability.

16. The digital pass method of claim 9, the method further comprising using at least one identifier for the at least one user from which the digital pass system to collect data, the at least one identifier set apart from user-provided identity information.

17. A digital pass system comprising:
a network interface assembly comprising one or more network devices;
at least one control circuit assembly adapted to receive and transmit information via the network interface assembly;
a promotional interface adapted to communicate with at least one user, the user initiating the communication from at least one mobile computerized device, the user further able to retain personal identity information when interfacing the promotional interface;
the promotional interface adapted to operate within a promotional environment having at least one or more of a proximity spatial element, a time window temporal element, a products material element, and a risk element, the proximity element including user trajectory, the risk element adapted to calculate outcome probabilities from the at least one user;
at least one or more of an NFC tag adapted to detect the user's mobile computerized device about 0-2 inches from at least one portion of the network interface assembly, global positioning system, Bluetooth beacon assembly adapted to enable notifications of user approaches within about 1-33 feet of at least one portion of the network interface assembly, and a geofencing system adapted for determining a presence of the at least one user within the promotional environment the promotional environment within 10 to 3,280 feet of promotional message origin the selected geofence boundary variable for each promotion;
at least one user interface wherein the at least one user may create through a digital pass portal at least one digital pass on at least one computerized device adapted to accept receipt of at least one or more of information, coupons, and transactions via the network interface assembly, the user interface disposed on the at least one computerized device adapted to receive a user component of the digital pass system by at least one or more of scanning and tapping an optical code, a computer link, text, email, and an NFC tag;
the at least one mobile computerized device adapted to register at least one push notification service to provide a unique, secure, and randomized token into the digital pass wherein digital pass software can determining from user data, location, and trajectory, if, when, and to whom to send information via the network interface assembly based on user vectors of the at least one user;
the network interface assembly sending information to the at least one digital pass as prompted by the digital pass software based on at least one or more of the location of an at least one user, a time, a material associated with the information, and a probability the at least one user will respond to information positively, the probability further determined by at least one or more of past behavior statistics data and predictive algorithms, from at least one or more from a group of: decision trees, neural networks, Bayesian networks, genetic programs, and nearest neighbors, the predictive algorithms further adapted to use data the user has permitted the digital pass software to receive, further adapted to have assigned at least one identifier for each given user from which the digital pass system improves at providing relevant messages to that given user;
the at least one user initiating the receipt of at least one or more of information, coupons, and transactions by at least one or more of interfacing with the promotional interface and sending a request for a digital pass, the digital pass further adapted to receive messages and have messages erased by way of the control circuit assembly; and
the promotional environment adapted to seek information about the user, gain perspective on that information, make decisions from that information, take action on the information, and assess results of information use.

18. The digital pass system of claim 17 further comprising at least one or more of a pass store wherein users can find, present, and transact digital passes, an ad network wherein users are presented with localized advertising, and a pass marketplace wherein users may find, present, and incorporate features into the digital pass.

19. The digital pass system of claim 17, wherein the user interfaces with at least one QR code.

20. The digital pass system of claim 17, wherein at least one identifier for the at least one user from which the digital pass system is adapted to collect data, the at least one identifier set apart from user-provided identity information.
